(19) United States
(12) Patent Application Publication
(10) Pub. No.: US 2012/0331557 A1
(43) Pub. Date: Dec. 27, 2012

(54) Global identity protector E-commerce payment code certified processing system

(76) Inventor: Keith Anthony Washington, Oakland, CA (US)

(21) Appl. No.: 13/134,924

(22) Filed: Jun. 21, 2011

(51) Int. Cl. G06F 21/00

(52) U.S. Cl. 726/26

(57) ABSTRACT

An identity theft protection system and method which employs several security features to prevent identity theft on all levels. The protection system database employs a member's address and telephone number as a numeric identity protector, security code and lock for Social Security numbers. Preventing the issuing of identity theft credit cards, and e-commerce address billing payment code numbers, and e-commerce telephone number billing payment code numbers. The locking address also prevents account hijacking, preventing checks from being mailed to identity thieves. The system employs a computer generated photo copy of the member's ID or drivers license, to prevent fraud on all big ticket items, and preventing identity theft bank fraud on checking accounts and medical records providing photo match and verify, identity theft prevention verification. The system protects its members against stolen and counterfeit checks. The G.I.P. computer database will ID the owner of the checking account at the cash register. The ID can also prevent cyber identity theft, also known as account hijacking.

### BACKGROUND OF THE INVENTION

This invention relates to the prevention of identity theft. A system which protects a person's identity by employing a person's address and telephone number as a numeric global identity protector security code and lock for Social Security numbers. And the system employs a computer generated photo ID to prevent identity theft fraud on all over the counter transactions.

### Description

In the course of a busy day, you may write a check at the grocery store, charge tickets to a ball game, rent a car, mail your tax returns, call home on your cell phone, order new checks or apply for a credit card. Chances are you don't give these everyday transactions a second thought. But someone else may.

The 1990's spawned a new variety of crooks called identity thieves. Their stock in trade is your everyday transaction. Each transaction requires you to share personal information: your bank and credit card account numbers; your income; your Social Security number or your name, address and phone numbers. An identity thief co-opts some piece of your personal information and appropriates it without your knowledge to commit fraud or theft. And all-too-common example is when an identity theft uses your personal information to open a credit card account in your name.

Identity theft is a serious crime. People whose identities have been stolen can spend months or years and thousands of dollars cleaning up the mess the thieves have made of their good name and credit record. In the meantime, victims may lose job opportunities, be refused loans for education, housing, cars, or even be arrested for crimes they didn't commit. Humiliation, anger and frustration are common feelings victim's experience as they navigate the arduous process of reclaiming their identity. Perhaps you've received your first call from a collections agent demanding payment on a loan you never took out, for a car never bought. Maybe you've already spent a significant amount of time and money calling financial institutions, canceling accounts, struggling to regain your good name and credit.

From a consumer complaint to the FTC, Feb. 22, 2001. In one notorious case of identity theft, the criminal, a convicted felon, not only incurred more than $100,000 of credit card debt, obtained a federal home loan, and bought homes, motorcycles and handguns in the victim's name, but called his victim to taunt him saying that he could continue to pose as the victim for as long as he wanted because identity theft was not a federal crime at that time, before filing for bankruptcy, also in the victim's name. While the victim and his wife spent more than four years and more than $15,000 of their own money to restore their credit and reputation, the criminal served a brief sentence for making a false statement to procure a firearm, but made no restitution to his victim for any of the harm he had caused.

U.S. Uncovers large-scale identity theft scheme used by illegal aliens to gain employment at nationwide meat processor worksite. Enforcement investigation reveals that hundreds of U.S. citizens and lawful residents may have been victimized. Approximately 1,282 persons have been arrested as part of an ongoing worksite enforcement investigation violations and a massive identity theft scheme that has victimized large numbers of U.S. citizens and lawful U.S. residents. In total, agents apprehended 1,282 illegal alien workers on administration immigration violations at Swift facilities. Of these, 65 have been charged with criminal violations related to identity theft. This investigation has uncovered a disturbing front in the war against illegal immigration. We believe that the genuine identities of possibly hundreds of U.S. citizens are being stolen or hijacked by criminal organizations and sold to illegal aliens in order to gain unlawful employment in this country.

Evidence uncovered during the investigation, indicates that hundreds of these illegal aliens may have illegally assumed the identities of U.S. citizens and improperly used their Social Security numbers and other identity documents in order to gain employment at Swift facilities. ICE and the FTC have identified hundreds of U.S. citizens whose stolen identities have been used by these aliens and have reported being victimized by this identity theft scheme. The investigation has uncovered criminal orgahization around the country that traffic in genuine birth certificates and Social Security cards belonging to U.S. citizens. ICE agents learned that many of these genuine identity documents were trafficked to locations around the country and sold to illegal aliens who used them to gain employment at Swift. By using valid Social Security numbers and birth certificates of U.S. citizens, these illegal aliens were able to thwart the Basic Pilot Employment Eligibility Verification system, a federal program designed to help employers detect unauthorized workers.

The FTC has received hundreds of complaints from U.S. citizens across the country who allege that they became aware that their identities were being used illegally. Among the victim complaints were: A victim in Texas stated their personal information was used for employment. Victim also reported he was pulled over and arrested since the suspect used his information for illegal activity. Victim in Texas reports that suspect obtained utility accounts and a Sprint wireless account using their information.

Generally, identity thieves use their victim's personal data to steal financial accounts and run up charges on their existing credit cards. However, the damage does not stop there. Identity thieves can also cause havoc with their victim's tax records. David Hodge got a shock when he filed his federal tax returns last year. An identity thief had beaten him to it. “I was stunned,” says Hodge, a 33-year-old Mount Vernon, N.Y. home-improvement contractor, recalling the moments his accountant told him the IRS had rejected his return because someone had already filed using his name and Social Security number. “How could somebody do that?. Hodge contacted the IRS. He says the tax agency told him to produce copies of his Social Security card and birth certificate within 30 days, “or else I would probably have more problems with that number.” Unable to comply by the deadline, Hodges says, he left “message after message after message” with the IRS seeking an extension, “but nobody called me back, ever”. He didn't know whether the problem had been resolved. Even as the Tuesday federal tax deadline looms, Hodge's experience is becoming more common. Federal Trade Commission complaints involving tax returns linked to identity theft rose to 20,782 in 2007, up 158% since 2003. Similar complaints to the IRS Taxpayer Advocate jumped to 3,327 in federal fiscal year 2007, up 644% in three years.

Nina Olson, head of the IRS Taxpayer Advocate office, reported to Congress early this year that identity theft has emerged as one of the top problems facing taxpayers. Olson said in an interview she believes the statistics only hint at the size of the problem. “If you want quantification, we don't know,” Olson says. “The IRS has no idea how many cases of identity theft exist.” The nightmare is spreading, according to USA TODAY interviews with more than a dozen accountants and other tax experts nationwide.

Often, the goal is to collect an undeserved tax refund, file with one stolen identity, claim multiple dependents and apply for the federal Earned Income Tax Credit, and an identity thief can snag a tax refund worth thousands of dollars, or more. Diana, Aliffi, a Riverhead, N.Y., accountant, allegedly stole former clients personal information in a scam that could have netted her up to $19 million in tax refunds, according to an indictment unsealed Wednesday in Suffolk County Court. Alternately, taking another's identity can help thieves hide a criminal conviction, illegal-immigration status or other problem that could block them from getting a job. Their employers file W-2 wage-reporting forms with the IRS, which attributes the income to the true owner of the Social Security number. Victims don't discover the problem until the IRS contacts them with questions about under-reported income.

Either way, the thieves victims confront weeks or months of bureaucratic wrangling to verify their identity at best, or suffer longer-term financial damage at worst. A New York State Police trooper whose identity was stolen last year waited from February until September to get his anticipated tax refund as the IRS sorted out the problem, says Dianne Corsdie, the enrolled agent who prepared and filed his tax return. “He was counting on that refund to pay his real estate tax bill. He didn't have the money to pay on time . . . and he had to pay penalties and interest, so of course it was a hardship,” says Corsbie, a tax preparer at Bocor & Associates in White Plains, N.Y.

The FTC and the World Privacy Forum (WPF) have each published reports on medical identity theft. The FTC looked specifically at medical identity theft for the first time in their annual ID theft survey. These statistics are the first of their kind in the medical security field, affirm the conclusions of the WPF report published earlier in the year.

According to the FTC Report, 3% of all identity theft victims in 2005, approximately 250,000 people, were victims of medical identity theft. These victims had their information used to receive medical care, benefits, or to get medical insurance. The WPF cites the danger of this type of identity theft. “The reports finds that one of the significant harms a victim may experience is a false entry made to his or her medical history due to the activities of an impostor Erroneous information in health files can lead and has led to a number of negative consequences for victims.

Currently, it is difficult to recover from medical identity theft. Unlike credit reports, patients do not have the same rights to correct errors in their medical histories, nor do they have a right to receive a free copy of their medical file (as one would a credit report). Medical identity theft can lead to credit issues if the false identification is used for expensive hospital visits. These false entries on medical files can exhaust an individual's medical coverage and, in some cases, make them uninsurable (e.g. having a disease on record that is not yours) or unemployable (psychiatric history).

Medical identity theft may never be discovered unless an out standing bill, or in correct medical treatment, surfaces. Because medical identity theft is difficult, and sometimes never detected, it may be much more prevalent than the statistics reveal.

Future terrorism acts will heavily rely on identity theft of innocent people. Of course past terrorism acts have relied on identity theft to plan and execute their acts, however, as governments of the world continue to fight terrorism by cutting the terrorist organizations' financial sources, terrorists have no other choice but to rely on innocent people's identity to fund their terrorism acts. Fraudulent drivers licenses, illegal aliens and terrorism, all things that are being helped along by fraud rings at DMV's around the country. Some of the 9/11 hijackers had fraudulent drivers licenses and they are sought after by illegal aliens across the country because they not only allow you to drive, but to open bank accounts, get on planes and in general move freely throughout the United States.

Florida is a place where people could buy fraudulent driver's licenses for as much as $3,500 without having to produce any identification. DMV workers took payoffs for stealing the identities of legitimate license holders. In New Jersey, nine state motor vehicle employees pleaded guilty to a scheme that involved payoffs for bogus licenses. In Illinois, a federal investigation into the trading of bribes for driver's licenses led to dozens of convictions and indictment of former Gov. George Ryan on racketeering and other charges. In Virginia, more than 200 people are losing their licenses because of suspected fraud by a former Department of Motor Vehicles worker who allegedly sold licenses for as much as $2,500 each. A $4,000 line of credit was taken out in the name of Patrick Milling, an assistant principal in Farmington, to buy an expensive watch and diamonds. Another fake ID card was used to withdraw $11,500 from the bank account of a Bristol man. A DMV employee allegedly received an envelope containing $700 for issuing one of the fake ID cards.

In a briefing given in late September 2001, Ronald Dick, assistant director of the FBI and head of the United States National Infrastructure Protection Center (NIPC), told reporters that the hijackers of 9/11 had used the Internet, and “used it well”. Terrorist manuals found on laptop computers in Afghanistan instructed would be terrorists they can find 80% of everything they need to know about Americans through the public records. The NIPC issued an advisory on Jan. 17, 2002 which cautions municipalities to review the content of their website to protect against-the inadvertent disclosure of critical infrastructure information. The NIPC has received reports that: infrastructure-related data is being accessed through the Internet from sites around the world.

Hamilton County Clerk of Courts Greg Hartmann understood the link when he told the Cincinnati Post he was removing more than 320,000 public documents from his web site in an attempt to combat the growing crime of identity theft. “I have seen increasing numbers of identity theft,” Hartmann said “we have had a number of cases where police have told me the bad guys got the information used to steal identities from my web site. Citizens there have filed a lawsuit against the county for the breach of their security.

In a press release dated July 2005 titled ID Theft Isn't Just For Grownups, Utah Attorney General Mark Shurtleff, announced the arrest of several thieves using the identities of children as young as five years old. The investigation uncovered an alarming new crime spree involving illegal aliens and identities stolen from victims under the age of 12. Investigators checked Utah state records and found that approximately 1,800 Social Security numbers, belonging to children under the age of 13, may have been compromised.

If this background information contained all of the problems caused by identity theft, the reader would be Exhausted, before reading the claimed invention. The claimed invention makes identity theft one of the easiest problems in the world to control, and bring to a complete end. The present invention does so with two sheets of paper, and a computer database. The reader will find that the solutions are simple, but not obvious.

Millions of Americans have been victims of identity theft, costing the U.S. an average $53 billion per year. Identity theft is now the world's fastest growing crime.

### OBJECTS AND ADVANTAGES

Accordingly, several objects and advantages of the present invention are:
(a) To provide a system which can prevent the issuing of identity theft debit or credit cards.
(b) To provide a system which can prevent a person from purchasing an automobile with another person's Social Security number.
(c) To provide a system which can prevent a person from purchasing real estate, with another person's Social Security number.
(d) To provide a system which can prevent a person from opening a bank account with another person's Social Security number.
(e) To provide a system which can prevent a person from calling a bank and changing another person's mailing address to commit fraud.
(f) To provide a system to prevent an innocent person from being arrested for passing counterfeit checks.
(g) To provide a system to prevent a person from obtaining employment with another person's Social Security number.
(h) To provide a system to prevent a person from filing a tax return with another person's. Social Security number.
(i) To provide a system to prevent a person from doing anything illegal with another person's Social Security number.

### BRIEF SUMMARY OF THE INVENTION

Accordingly, the reader will see that this identity protection system can be used to prevent identity theft easily and conveniently. The system contains all of the necessary features to prevent identity theft fraud on all levels. Preventing the possibility of issuing identity theft debit or credit cards, by employing the actual digits of a member's address and telephone number, as a security code and lock. And employing a computer generated photo copy of the member's identification to prevent identity theft on all over the counter transactions.

### DETAILED DESCRIPTION OF THE INVENTION

Any person who wants protection from identity theft, can simply download an identity theft protection system form, fill it out in long hand, have it notarized, and return it for filing. The system form is then loaded into a computer database, Global Identity Protector (GIP). This system database is set up to give banks and every other institution, a rock solid tool to work with to prevent identity theft. All institutions and credit granters will log on, and enter an access code, a page will appear, they will then enter a member's name and Social Security number, (SSN). The identity theft protection page on that member will now appear for reviewing.

This system contains several security features, the member's full name, in case the identity thief only knows the member's first and last name. The system contains a full description and photo, the member will submit a computer generated photo copy of their ID, or drivers license. This is for all applications that are filled out in person, and cyberspace transactions for online sellers, and for registering the member's checking account numbers. The copy of the ID will prevent the use of stolen, and counterfeit checks. If the photo ID the person is carrying in his or her wallet is not the same as the one on the G.I.P. protection system, no credit will be granted, or checks will be cashed.

The system will employ three security codes, one of which will not appear on the system itself. When an institution is reviewing the system, one of the codes will be entered into a box labeled security code. The computer will only tell the institution if the code is correct or incorrect. This feature is in the system for credit cards that are applied for over the phone, online, or by mail. The true purpose for this code is to block a family member or spouse who can obtain all of the necessary information to commit fraud. The system will also contain the member's code name, to give the institution another security feature to verify.

The system contains the member's current full mailing address. The member's SSN, and mailing address will be combined, such as, 457-55-5462+2201.APT.E.94606.

This feature alone will prevent the perpetrator from receiving credit cards or checks in the mail. The institution will use the digits that are locked to the member's SSN, to issue a fraud proof e-commerce address billing payment code, or a common credit card. The address on the system is the only address institutions are authorized to send the member's credit cards and checks to. The system also contains the member's telephone number, which will also be locked to the member's SSN, such as, 457-55-5462+(510)700-0000 the institution will issue a fraud proof e-commerce telephone number billing payment code.

The system will allow the member to submit several addresses and telephone numbers for mailing checks and credit cards. Each address and telephone number will be physically locked to the member's SSN. The actual digits of the member's address and telephone number will follow their SSN, employing the address and telephone number as an identity protector, security code and lock, for the issuing of e-commerce payment code numbers. Which are active billing numbers just like common credit card numbers. But e-commerce payment code numbers are fraud proof, and made up from the actual numbers of the person's address and telephone number. The issuing payment code numbers will be match to the numbers of the member's address and telephone number, verifying the owner of the SSN. After the owner of the SSN has been verified, the issuing payment code numbers are manually entered into the Address Billing Computer Database.

The system will also contain the member's penmanship, all personal information on the system is handwritten not typed. If the penmanship or signature doesn't match, credit will not be granted. The system contains the signature of a notary, certifying that all of the information submitted has been verified. The system will also contain the member's thumbprint. If the person does not have hands, they will download a special form requesting the notary to submit their print as a data entry key. This will prevent any employees from removing one system and replacing it for another with false information.

### Operation

The manner of using G.I.P. is very simple and informative. If a perpetrator acquires a member's complete banking information, such as, account number, mailing address and SSN. With the intent of hijacking the member's bank account, to have checks or credit cards sent to a drop address. After the bank talks to the perpetrator about sending the checks or credit cards. The bank will simply enter the member's name and SSN into the G.I.P. computer database to verify the owner of the SSN. The bank will then review the notarized document. The bank will treat the address and telephone number that is locked to the member's SSN, as a security code and lock.

The numbers will start off as a security code. The bank will perform a one step process and match the issuing payment code numbers of the perpetrator's address to the certified address that is locked to the member's SSN. If one security code number does not match, the security code number will become a lock. If the numbers match, the bank will issue an e-commerce address billing payment code, or telephone number billing payment code, with the same numbers that are locked to the SSN. If the numbers don't match the bank will then inform the perpetrator that a new notarized protection system form must be submitted before checks or credit cards can be sent to a new address.

The member's SSN and current mailing address and telephone number are combined, turning the member's address and phone number into a security code and lock, that only they can change. The G.I.P. system blocks any fraudulent activity dealing with anything that is mailed. Financial institutions will mail the member's checks or credit cards within an envelope printed with DO NOT FORWARD.

If the perpetrator goes online to order credit cards, after the application has been received by the bank or store, they will simply enter the member's name and SSN into the G.I.P. computer database. They will see that the address or telephone number on the application is not the same as the one locked to the member's SSN. If the perpetrator tries to order credit or debit cards by phone, the bank will ask the person for their security code, and code name. If the perpetrator was a family member or spouse, and they live at the address of the person's identity that they are trying to steal, the security code will block the transaction. The security code will be known only by the person who owns it.

If the perpetrator goes to an auto dealership or financial institution etc. after the perpetrator fills out the loan application, the institution will enter the person's name and SSN into the G.I.P. computer database. They will see a computer generated photo copy of the member's ID or drivers license. The G.I.P. computer database providing photo match and verify, identity theft prevention verification. The institution will match the photo and signature of the actual identification the person is carrying in his or her wallet. If these things do not match, they can call the police and have the perpetrator arrested on the spot. The G.I.P. computer database can also prevent identity theft with the purchasing of real estate. The agent can offer the customer the convenience of refinancing a G.I.P. registered property address, electronically.

The G.I.P. system will also protect its members against check fraud. If the member's checks are stolen, or counterfeited, and the perpetrator goes to a department store etc. The store will simply enter the member's account number or ID number into the G.I.P. computer database, and the member's true identity will appear on the screen. The clerk will see a computer generated photo copy of the member's ID. The clerk will then compare the ID with the ID the person is carrying, and match signatures with the check and the on screen ID, in case the member is a twin.

If an identity thief goes to a hospital seeking medical care with a G.I.P. member's SSN. The hospital will simply enter the person's name and SSN into the G.I.P. computer database, and see the notarized document, and photo ID of the true owner of the SSN. The hospital will simply inform the patient that medical care cannot be provided under this SSN. If the patient is registered in the G.I.P. computer database, the hospital can treat the patient, and provide a secure method for the patient to manage their health care online.

If the member has a child under the age of 18, they can register the child's SSN with their own. When the child's number is entered in the computer database, the parent's identity will appear. Informing the institution the SSN number they have entered belongs to a person under the age of 18, and provide the parent's telephone number. Members will also be able to register a deceased family member or spouse. When the deceased person's SSN is entered in to the computer database, G.I.P. will inform the institution that the individual is deceased.

If the perpetrator applies for life or medical insurance with a home visit from the insurer. After the agent leaves the person's home and returns to the office, they will simply enter the person's information into the G.I.P. computer database, and verify the person's identity, and their home address.

The G.I.P. system can also prevent cyber identity theft, also known as account hijacking. For instance, there are online auction houses that use a rating system which gives seller's points for every transaction. Therefore, perpetrators are employing every trick in the book to steal a seller's personal information, in order to hijack the seller's account, and good rating. With the intent of posting goods for sale that do not exist. A buyer will bid on the item, when the auction ends, the perpetrator will tell the buyer where to mail payment for the item. If the seller is registered in the G.I.P. computer database, the buyer will see a G.I.P. logo and link, on the auction page, which informs the buyer that the seller's identity and mailing address can be verified. The system will work with any online seller who wants the buyer to feel safe about their purchase.

Global Identity Protector can prevent any identity theft crime imaginable. The computer generated photo ID can be accessed from anywhere in the world, for verifying any person's identity for over the counter transactions, or Internet transactions. The computer generated photo ID can verify an online seller and buyer's age, address and identity. Providing the online seller and buyer with crucial information about the person they are doing business with. Only a legitimate seller and buyer would be interested in registering their identity for online authentication. The G.I.P. computer database can provide the online seller with customer information that would prevent the need to establish an account at all, in order to make a purchase.

1. A computer based method for preventing identity theft fraud, protecting a person's social security number and name, by uploading a certified identity verification system document, into global identity protector (GIP) computer database, providing a computer generated certified document of the person's personal information for identity verification, the G I P computer database, comprising:
(a) a first computer means with a providing scanner for capturing and uploading said certified identity verification system document into said G I P computer database,
(b) an institution will access providing said certified identity verification system document from a second providing computer means, by entering the person's social security number into said G I P computer database,
(c) verifying the person's identity, by reviewing providing said certified identity verification system document, processing and matching the person's signature, and certified address and telephone number, to a provided signature, address, and telephone number, if the provided signature address or telephone number does not match the providing said certified identity verification system document, all services will be denied against the social security number,
a means for providing certified identity verification, providing computer generated certified document identity theft prevention certification,
whereby said global identity protector provides certified documents, which provides certified address and telephone number digits, as a numeric identity protector, security code and lock for social security numbers, which can prevent a perpetrator from changing a person's address and telephone number to commit identity theft fraud, preventing the issuing of identity theft credit cards, and e-commerce address billing payment code numbers, and e-commerce telephone number billing payment code numbers,
by matching each issuing payment code number to the provided certified address and telephone number, before entering the issuing payment code numbers into the address billing computer database, said G I P computer database is an e-commerce payment code certified processing system.

2. A computer based method for preventing identity theft fraud, protecting a person's social security number and name, by uploading a copy of the person's ID or drivers license, into global identity protector (GIP) computer database, providing a computer generated image of a person's ID or drivers license, for the process of photo to photo match and verify, and address to address match and verify, said G I P computer database, comprising:
(a) a first computer means with a providing scanner for capturing and uploading said ID or drivers license face information, into said G I P computer database,
(b) an institution will access the person's current providing said computer generated photo ID and mailing address, from a second providing computer means, by entering the person's social security number, or ID drivers license number,, into said G I P computer database,
(c) verifying the person's identity by reviewing the person's current mailing address, and matching the G I P member's providing said computer generated photo ID to the person's ID and signature they are carrying,
(d) if providing said G I P computer generated photo ID image or mailing information is not a match to the person's ID image and mailing information, all services will be denied against the provided social security,
a means for providing computer generated photo image identification, providing photo match and verify identity theft prevention verification,
whereby said global identity protector provides a current computer generated photo image copy of an ID or drivers license which can prevent all identity theft fraud on all over the counter transactions involving a person's social security number, or ID number which can identify a checking account holder at the cash register, the computer generated ID can also prevent cyber identity theft, also known as account hijacking, the address on the ID can prevent a perpetrator from changing a person's mailing address which can be used as a security code and lock, said G I P computer database can prevent any identity theft fraud imaginable.
